(19) United States
(12) Patent Application Publication
(10) Pub. No.: US 2020/0356892 A1
(43) Pub. Date: Nov. 12, 2020

(54) SYSTEMS AND METHODS FOR GENERATING ADVERSE-ACTION REPORTS FOR ADVERSE CREDIT-APPLICATION DETERMINATIONS

(71) Applicant: Bluestem Brands, Inc., Eden Prairie, MN (US)

(72) Inventors: Weiping Liu, Chanhassen, MN (US); James Hafstad, Maple Grove, MN (US)

(21) Appl. No.: 16/404,368

(22) Filed: May 6, 2019

(51) Int. Cl. G06N 20/00

(52) U.S. Cl. CPC G06N 20/00

(57) ABSTRACT

Disclosed herein are systems and methods for generating adverse-action reasons for adverse credit-application determinations. In an embodiment, a server calculates a log-odds contribution for each of multiple input variables of a machine-learning model for each of multiple training-data observations. The server identifies a working minimum log-odds contribution and from that a maximum score for each input variable. The server calculates a log-odds contribution and from that an actual score for each input variable for an application data set. The server calculates a score difference between the maximum and actual scores for each input variable. The server outputs an adverse-action report that is associated with the application data set. The adverse-action report includes an indication for each of a predefined number of the input variables having the highest score differences.

### FIELD OF THE DISCLOSURE

The present disclosure generally relates to the evaluation and processing of results of machine-learning models, and more particularly to systems and methods for generating adverse-action actionable reasons for adverse credit-application determinations, as described in more detail below.

### SUMMARY

Machine-learning models are often generated and applied in contexts in which there are a relatively high number of input variables and there is a desire or need for a predictive model that can, in a forward-looking way, assess a given set of values that correspond respectively to some or all of those input variables and accordingly generate a prediction regarding the value of a certain variable that is referred to in this context as the target variable. One type of machine-learning model is known as a neural network. Other approaches to building machine-learning models involve use of decision trees, logistic regression, and other techniques. Machine learning is sometimes referred to as artificial intelligence. Moreover, machine-learning models are often generated using training data, which typically includes a relatively large set of data records that each contain values for some or all of the input variables and that further each contain values for the target variable. In the context of a given training-data record or model prediction, the value of the target variable could be a member of a discrete set such as {0, 1}, {true, false}, or {red, green, blue}, as examples, but could instead be a numerical value, among other examples.

One context in which machine-learning models are utilized in today's modern economy is in the disposition (i.e., the granting or denying) of credit applications that are made by consumers to potential lenders. Some such applications relate to traditional credit cards while others relate to merchant-specific (e.g., department-store-specific or electronics-store-specific) credit cards, as examples. Other examples include financing arrangements related to the purchase of automobiles, windows for a home, security equipment for a home or office, and/or the like. Such applications can be made in person, over the phone, and/or via a data connection (via, e.g., the Internet using, e.g., an app or a web browser).

In this context, example model input variables include savings-account balance and/or checking-account balance, length of credit history, number of open credit accounts, total credit balance, total credit balance as a fraction or percentage of total credit limits, number of credit-score inquiries within a certain preceding time frame, number of on-time payments within a certain preceding time frame, number of timely payments within a certain preceding time frame, number of minimum payments within a certain preceding time frame, number of missed payments within a certain preceding time frame, features of the credit line being considered (e.g., credit limit, minimum payments required, interest rate, compounding schedule), and/or the like. Some example target variables include a credit score, a percentage chance of default on a credit line (perhaps within a certain, defined period of time) were one to be extended, and a binary result indicating whether the percentage chance of default exceeds a given threshold, among other examples that could be listed here.

Thus, in an example situation, a lender builds a machine-learning model using training data that includes a relatively large number of observations, each of which includes respective values for some or all of the model input variables for a given past credit application (that was granted), and each of which also includes an indication as to whether or not that particular applicant defaulted on the extended credit line, perhaps within a defined amount of time. The lender then uses the model to process incoming applications that each have values for some or all of the input variables. In a typical example, for each such application, the machine-learning model outputs a binary indication as to whether the probability that the associated applicant would default on the credit line—within the predefined amount of time, were the credit line to be extended—exceeds or does not exceed a threshold that may represent a risk tolerance of the lender.

Upon making an adverse determination with respect to a given credit application (e.g., a determination to deny the application), the associated potential lender will typically generate and provide to the associated applicant a report of one or more of the reasons why the potential lender made that determination. Such a report is often referred to as an adverse-action report, and it is often the case that each of the one or more reasons listed in an adverse-action report corresponds respectively to what is known as an error code, which is typically an alphanumeric identifier that is uniquely associated with a respective adverse-action reason in a list of adverse-action reasons. Potential lenders provide adverse-action reports to denied applicants for various reasons such as promoting consumer confidence, gaining a competitive edge, avoiding appearance of impropriety, complying with applicable laws and/or regulations, and/or other reasons.

Disclosed herein are systems and methods for generating adverse-action reasons for adverse credit-application determinations.

One embodiment takes the form of a method that includes, for each of M training-data observations, calculating a respective log-odds contribution for each of N monotonic input variables of a machine-learning model. The method also includes, for each of the N input variables, identifying a respective working minimum log-odds contribution based on training data, as described in more detail below. The method also includes, for each of the N input variables, calculating a respective maximum score based on the identified working minimum log-odds contribution for the respective input variable. The method also includes receiving an application data set that includes a respective value for each of the N input variables of the machine-learning model. In certain embodiments, the method handles missing values for an input value. The method also includes calculating, based on the machine-learning model and the respective values in the application data set, a respective log-odds contribution for the application data set for each of the N input variables. The method also includes, for each of the N input variables, calculating a respective actual score based on the respective calculated log-odds contribution for the application data set. The method also includes, for each of the N input variables, calculating a score difference as the difference between the respective maximum score and the respective actual score. The method also includes outputting an adverse-action report associated with the application data set, the adverse-action report comprising a respective indication for each of a predefined number of the N input variables having the highest calculated score differences.

Another embodiment takes the form of a method that includes generating a machine-learning model having N monotonic input variables. The method also includes receiving an application data set that includes a respective value for each of the N input variables of the machine-learning model. The method also includes calculating, based on the machine-learning model and the respective values in the application data set, a respective log-odds contribution for the application data set for each of the N input variables. The method also includes outputting an adverse-action report associated with the application data set, the adverse-action report comprising a respective indication for each of a predefined number of the N input variables having the highest absolute values of respective calculated log-odds contributions.

Other embodiments take the form of systems that include a communication interface, a processor, and data storage that contains instructions executable by the processor for carrying out the method described in either of the preceding paragraphs and/or any variation of such methods described herein. Still other embodiments take the form of computer-readable media (CRM) containing instructions executable by a processor for carrying out any one or more of the methods described in this disclosure.

Furthermore, a number of variations and permutations of the above-listed embodiments are described herein, and it is expressly noted that any variation or permutation that is described in this disclosure can be implemented with respect to any type of embodiment. For example, a variation or permutation that is primarily described in this disclosure in connection with a method embodiment could just as well be implemented in connection with a system embodiment and/or a CRM embodiment. Furthermore, this flexibility and cross-applicability of embodiments is present in spite of any slightly different language (e.g., process, method, steps, functions, sets of functions, and/or the like) that is used to describe and/or characterize such embodiments.

### BRIEF DESCRIPTION OF THE DRAWINGS

A more detailed understanding may be had from the following description, which is presented by way of example in conjunction with the following drawings, in which like reference numerals are used across the drawings in connection with like elements.

FIG. 1 is a diagram of an example communication context, including an example adverse-action-report-generation server, in which at least one embodiment can be carried out.

FIG. 2 is an architectural diagram of the example adverse-action-report-generation server of FIG. 1, in accordance with at least one embodiment.

FIG. 3 is a flow chart of a first example method that includes a first example subprocess, a second example subprocess, and a third example subprocess, in accordance with at least one embodiment.

FIG. 4 is a flowchart of the first example subprocess of FIG. 3, in accordance with at least one embodiment.

FIG. 5 is a flowchart of the second example subprocess of FIG. 3, in accordance with at least one embodiment.

FIG. 6 is a flowchart of the third example subprocess of FIG. 3, in accordance with at least one embodiment.

FIG. 7 is a diagram of an example structure of an example adverse-action reason-code data table, in accordance with at least one embodiment.

FIG. 8 is a graphical depiction of an example experimental correlation between top-ranked adverse-action codes and model-input-variable importance observed upon execution of the first example method of FIG. 3, in accordance with at least one embodiment.

FIG. 9 is a flow chart of a second example method, in accordance with at least one embodiment.

FIG. 10 is a graphical depiction of an example experimental correlation between top-ranked adverse-action codes and model-input-variable importance observed upon execution of the second example method of FIG. 3, in accordance with at least one embodiment.

### DETAILED DESCRIPTION OF THE DRAWINGS

### I. Introduction

To promote an understanding of the principles of the present disclosure, reference is made below to the embodiments that are illustrated in the drawings. The embodiments disclosed herein are not intended to be exhaustive or to limit the present disclosure to the precise forms that are disclosed in the following detailed description. Rather, the described embodiments have been selected so that others skilled in the art may utilize their teachings; accordingly, no limitation of the scope of the present disclosure is thereby intended.

In any instances in this disclosure, including in the claims, in which numeric modifiers such as first, second, and third are used in reference to components, data (e.g., values, identifiers, parameters, and/or the like), and/or any other elements, such use of numeric modifiers is not intended to denote or dictate any specific or required order of the so-referenced elements. Rather, any such use of numeric modifiers is intended solely to assist the reader in distinguishing any elements that are referenced in this manner from one another, and should not be interpreted as insisting upon any particular order or carrying any other significance, unless such an order or other significance is clearly and affirmatively explained herein.

Moreover, consistent with the fact that the entities and arrangements that are depicted in and described in connection with the drawings are presented as examples and not by way of limitation, any and all statements or other indications as to what a particular drawing “depicts,” what a particular element or entity in a particular drawing “is” or “has,” and any and all similar statements that are not explicitly self-qualifying by way of a clause such as “In at least one embodiment,” and that could therefore be read in isolation and out of context as absolute and thus as a limitation on all embodiments, can only properly be read as being constructively qualified by such a clause. It is for reasons akin to brevity and clarity of presentation that this implied qualifying clause is not repeated ad nauseum in the ensuing detailed description.

### II. Example Architecture

A. Example Communication Context

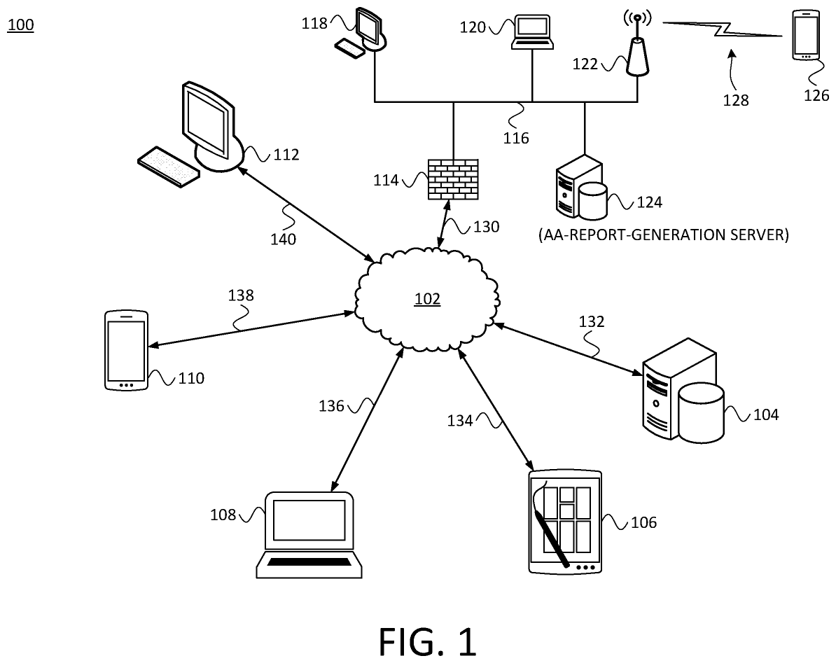

FIG. 1 is a diagram of an example communication context, including an example adverse-action-report-generation server, in which at least one embodiment can be carried out. In particular, FIG. 1 depicts an example communication context 100 that includes a data network 102 that facilitates communication among a number of entities. The devices, networks, and overall arrangement that are depicted in FIG. 1 are by way of illustration and not limitation—other arrangements, devices, networks, and/or the like could be used as well or instead.

The data network 102 could be or include one or more wired networks and/or one or more wireless networks. Each of the communication links 130-140, and in general any of the communication links described herein, regardless of their graphic depiction—could be or include one or more wired-communication links and/or one or more wireless-communication links. By way of illustration, the communication context 100 includes the following devices/systems in communication with the data network 102: a desktop computer 112 via the communication link 140, a smartphone 110 via the communication link 138, a laptop computer 108 via the communication link 136, a tablet 106 via the communication link 134, a network server 104 via the communication link 132, and a firewall/network access server (NAS) 114 via the communication link 130.

The firewall/NAS 114 is in turn connected to a local area network (LAN) 116, which could be or include a wired LAN and/or a wireless LAN. Also connected to the LAN 116 are a desktop computer 118, a laptop computer 120, a wireless access point 122, and an adverse-action-report-generation (AARG) server 124. In the depiction of FIG. 1, a smartphone 125 is communicatively connected to the wireless access point 122 via a wireless data connection 128. The depiction of the AARG server 124 as being connected to the LAN 116 and in general being behind the firewall/NAS 130 is by way of example and not limitation. The AARG server 124 could be connected directly to the network 102, among innumerable other possible arrangements.

B. Example Adverse-Action Report-Generation (AARG) Server

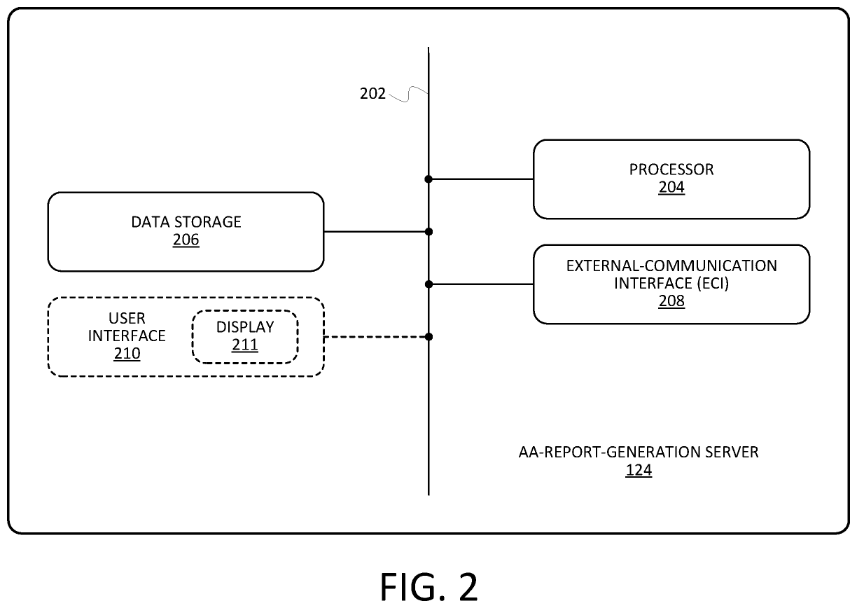

FIG. 2 is an architectural diagram of the AARG server 124. The architecture of the AARG server that is presented in FIG. 2 is by way of example only, as other suitable architectures could be used. As shown in the embodiment depicted in FIG. 2, the AARG server 124 includes a system bus 202 that communicatively interconnects a processor 204, data storage 206, an external-communication interface (ECI) 208, and an optional (as indicated by the dashed lines) user interface 210 that includes a display 211.

The processor 204 could be a general-purpose microprocessor such as a central processing unit (CPU), and the data storage 206 could be any suitable non-transitory CRM—such as ROM, RAM, flash memory, a hard disk drive, a solid-state drive, and/or the like—that contains instructions executable by the processor 204 for carrying out the AARG-server functions described herein. The ECI 208 includes one or more components such as Ethernet cards, USB ports, and/or the like for wired communication and/or one or more components such as Wi-Fi transceivers, LTE transceivers, Bluetooth transceivers, and/or the like for wireless communication. The user interface 210, if present, includes one or more user-input components such as a touchscreen, buttons, a keyboard, a microphone, and/or the like, as well as one or more output components such as the display 211 (which could be the aforementioned touchscreen), speakers, LEDs, and/or the like.

### III. Example Operation

### A. First Example Method

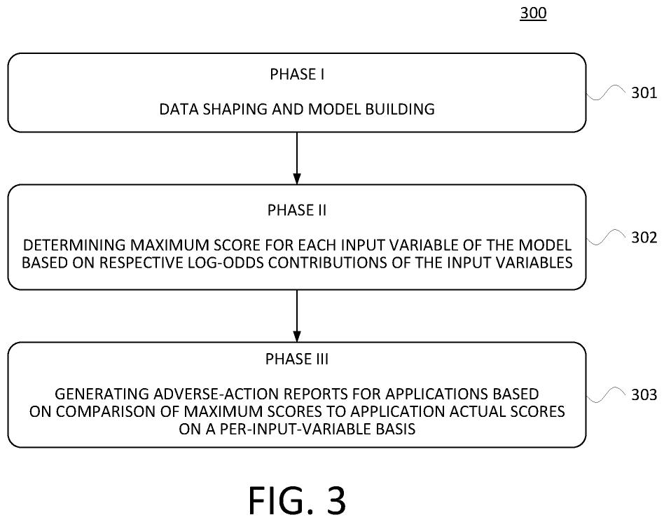

FIG. 3 is a flow chart of a first example method that includes a first example subprocess, a second example subprocess, and a third example subprocess, in accordance with at least one embodiment. In particular, FIG. 3 depicts a high-level, in this case a phase-level, view of a method 300 that contains three subprocesses: a Phase I subprocess 301, a Phase II subprocess 302, and a Phase III subprocess 303, each of which is described in turn below. As depicted in FIG. 3, the Phase I subprocess 301 involves data shaping and model building, the Phase II subprocess 302 involves determining a maximum score for each input variable of a machine-learning model (that is built during the Phase I subprocess 301) based on respective log-odds contributions of the input variables to that model, and finally the Phase III subprocess 303 involves generating adverse-action reports for credit applications based on a comparison of the maximum scores (determined during the Phase II subprocess 302) and actual application scores (that are determined during the Phase III subprocess 303) on a per-input-variable basis.

In the below description of all three subprocesses, references are made to a machine-learning model that is being built, as well as to a number of input variables. An example context is the processing of credit applications. In some embodiments, an external process (external is the sense of being outside the scope of the present disclosure) is used by a given organization to decide whether to grant or deny various credit applications based on a set of input variables such as any of those described above (e.g., number of missed payments within a certain preceding time frame, and so on). In instances in which the decision is to deny a given application, the present systems and methods can be used to generate an adverse-action report that lists a number of adverse-action reason codes, perhaps with their definitions, that correspond to one or more of the input variables. Such an adverse-action report can be outputted via a transmission to another computing device and/or stored in data storage of the AARG server 124.

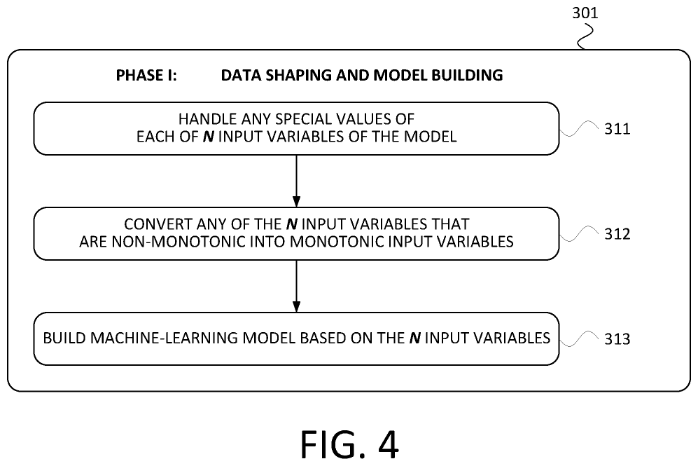

FIG. 4 is a flowchart of the Phase I subprocess 301, in accordance with at least one embodiment. As shown in FIG. 4, the Phase I subprocess 301 includes steps 311, 312, and 313.

At step 311, the AARG server 124 handling any special values of each of the N input variables of the model that is being built during the Phase I subprocess 301. In particular, the AARG server is operating on a set of M training-data observations that are each structured according to the N input variables of the model being built. In some cases, there will be no such special values. In cases where there are, however, such special values could include some predefined values set to, e.g., an effective infinity or a zero or some other fixed value, perhaps an error code or other alphanumeric message and/or identifier. In at least one embodiment, step 311 involves removing outlier values on a per-model-variable basis. Such an analysis may involve removing any values that are more than a threshold number of standard deviations from the mean of the data set for that particular model variable. Other example data-preparation steps that could be carried out as part of step 311 include merging, appending, aggregating values, finding and treating outliers, dealing with missing values, perhaps by deleting entire records, perhaps by interpolating in order to fill in missing values with imputed values, and/or the like.

At step 312, the AARG server 124 converts any of the N input variables that, in the set of M training-data observations, were previously non-monotonic input variables to being monotonic input variables. In at least one embodiment, an open-source software library known as XGBoost is used to carry out a number of the steps described herein. Tools in the XGBoost library can allow developers to create models by tuning various parameters or constraints such as monotonicity. In some embodiments, step 312 involves removing and/or modifying any values that would result in a given variable exhibiting non-monotonicity. An input variable is monotonic with respect to a target variable of a model if and only if, as the value of the input variable increases, the value of the target value is either non-decreasing (though it may increase) or non-increasing (though it may decrease).

At step 313, the AARG server 124 generates a machine-learning model based on the M training-data observations and based on the N input variables. In at least one embodiment, the AARG server 124 uses XGBoost to build the model. The built model may have the N input variables and may have a target variable such as the probability that a given applicant will default on a given line of credit within a particular time frame (e.g., 6 months).

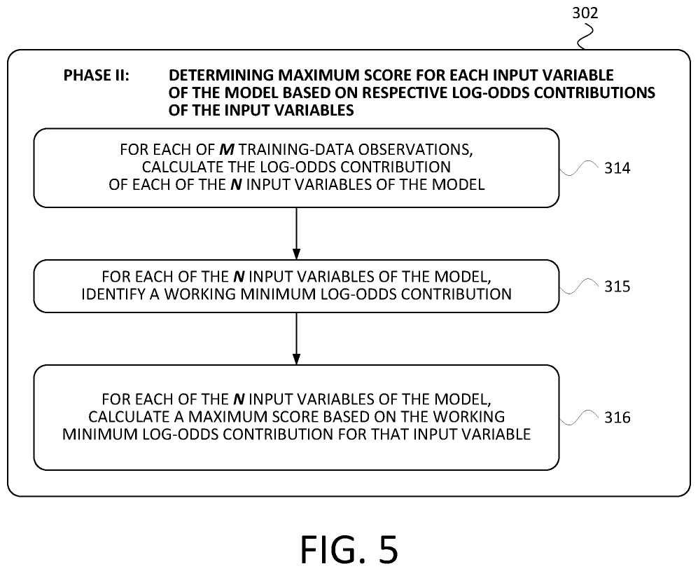

FIG. 5 is a flowchart of the Phase II subprocess 302, in accordance with at least one embodiment. As shown in FIG. 5, the Phase II subprocess 302 includes steps 314, 315, and 316.

At step 314, for each of the M training-data observations, the AARG server 124 calculates a respective log-odds contribution for each of the N monotonic input variables of the machine-learning model that was built in step 313. As a general matter, the odds of an event x is given by Equation 1:

$$odds ( x ) = \frac{p ( x )}{( 1 - p ( x ) )} \qquad ( Eq . 1 )$$

where p(x) represents the probability of the event x occurring. Furthermore, the log (i.e., logarithm) of the odds of the event x occurring (i.e., the log-odds(x)) is given by Equation 2:

$$log \text{-} odds ( x ) = ln ( \frac{p ( x )}{( 1 - p ( x ) )} ) \qquad ( Eq . 2 )$$

In general, in the arts of statistics, machine-learning, and the like, the natural logarithm is the default (i.e., most common) logarithm that is used, though other logarithms (e.g., base 10) could be used as well, so long as it was used consistently. It is also noted that the log-odds function is sometimes referred to as the “logit” function.

In at least one embodiment, the AARG server 124 uses an XGBoostExplainer package to calculate the log-odds contribution of each of the N input variables in each of the M training-data observations for a machine learning model developed using the XGBoost package. The log-odds contribution of a given variable refers to the value given back by the XGBoostExplainer package for a single observation for that particular variable. The XGBoostExplainer package provides a value referred to as a log odds contribution for each variable for a single observation along with an intercept for a single observation. The sum of all of the variable log-odds contributions and the intercept for a single observation gives the total log-odds of an event occurring for that particular observation, which, in turn, will be used to calculate the probability of the observation. The log-odds of an event occurring for observation k is given by Equation 2.5:

$$log \text{-} odds ( {x}_{k} ) = {c}_{k} + {\sum }_{i = 1}^{N} log \text{-} odds ( {var}_{k i} ) \qquad ( Eq . 2.5 )$$

where log-odds(xₖ) refers to the log-odds of event x (that is, in the present disclosure, target=1 or 0) occurring for observation k, cₖ refers to the intercept given by the XGBoostExplainer package for observation k, and log-odds(varₖᵢ) refers to the log-odds contribution for observation k and variable i given by the XGBoostExplainer package. N refers to the total number of input variables.

In at least one other embodiment, the AARG server 124 calculates all of the log-odds-contribution values, in some cases using a decision-management software platform from Experian known as PowerCurve. Whatever the manner of calculation, the carrying out of step 314 results in N log-odds-contribution values for each of the M training-data observations.

At step 315, for each of the N input variables, the AARG server 124 identifies a respective working minimum log-odds contribution. It is noted that this identified working minimum log-odds contribution for each of the N input variables is across all of the M training-data observations. That is, at step 315, the AARG server 124 identifies N different working minimum log-odds contributions, one for each of the N input variables of the model.

In some embodiments, for each given input variable, the working minimum log-odds contribution is simply the minimum (i.e., most negative) log-odds contribution among the M training-data observations. As examples, the working minimum log-odds contribution could be the maximum log-odds contribution among the 5% or 10% of the M training-data observations having the lowest calculated log-odds contributions for that input variable.

At step 316, for each of the N input variables, the AARG server 124 calculates a respective maximum score based on the identified working minimum log-odds contribution for the respective input variable. In at least one embodiment, for a given input variable i (denoted van the maximum score is given by Equation 3:

$$maximum\_score ( {var}_{i} ) = \frac{- log \text{-} odds - min ( {var}_{i} ) * PDO}{ln ( 2 )} \qquad ( Eq . 3 )$$

where log-odds-min is the working minimum log-odds contribution for the respective input variable as identified in step 315 and where PDO is the Points to Double the Odds. In the art, the PDO is a scaling factor that is used with, e.g., credit scores, and represents the number of points of increase of a credit score that corresponds with a doubling of the odds of a positive outcome (such as not defaulting on a given credit line within, e.g., 6 months). Some commonly used PDO values include 20 and 25. In some embodiments, a PDO of 60*ln(2) (i.e., approximately 41.59) is used. Numerous other values could be used as well.

It is further noted that each computed log-odds contribution from step 314 and therefore each identified working minimum log-odds contribution from step 315 are negative numbers, which is the reason for the negative sign prior to log-odds-min in Equation 3 above. Furthermore, because smaller (i.e., more negative) values of log-odds contributions correspond with higher scores per the above equations, the use of the log-odds-min from step 315 results in the computation of a score in step 316 being the computation of a maximum (or perhaps working maximum) score for each of the N input variables of the model. Thus, after the carrying out of step 316, N maximum scores have been calculated, one for each of the N input variables.

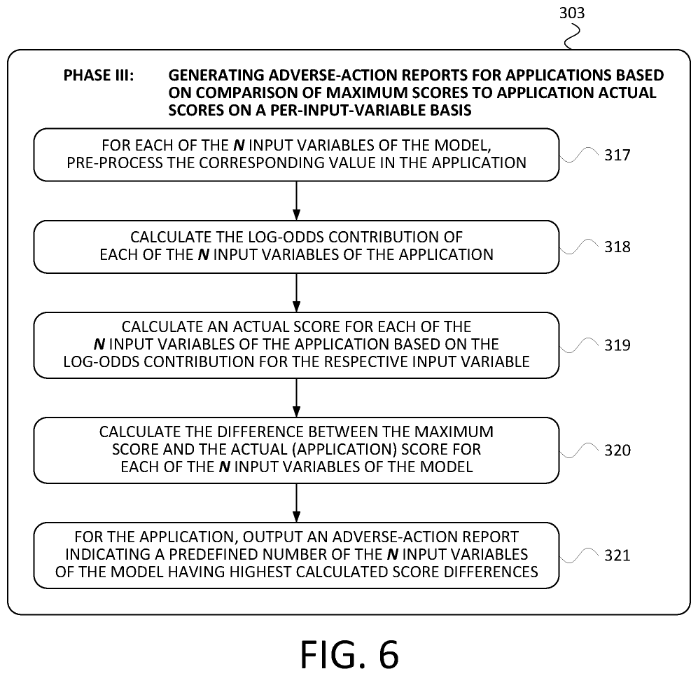

FIG. 6 is a flowchart of the Phase III subprocess 303, in accordance with at least one embodiment. As shown in FIG. 6, the Phase III subprocess 303 includes steps 317, 318, 319, 320, and 321.

At step 317, the AARG server 124 receives—and preprocesses if necessary—an application data set comprising a respective value for each of the N input variables of the machine-learning model. In at least one embodiment, the application data set corresponds with a credit application—in at least one such embodiment, the credit application has been denied pursuant to an external process as described herein. Such external process could make use of a neural network, among other options. The AARG server 124 may receive the application data set from its own data storage 206 or from another server or device such as any of the example devices described in connection with FIG. 1 or any other suitable device. In at least one embodiment, the AARG server 124 handles any special values similar to the manner described in connection with step 311. In some embodiments, the AARG server 124 imposes a cap (i.e., a maximum value) on one or more values in the application data set that correspond with positively monotonic variables and/or imposes a floor on one or more values in the application data set that correspond with negatively monotonic variables. Other preprocessing functions could be carried out on one or more of the input variables (i.e., the values corresponding to the input variables) in the application data set.

At step 318, the AARG server 124 calculates, based on the machine-learning model and the respective values in the application data set, a respective log-odds contribution for the application data set for each of the N input variables. The AARG server 124 may carry out step 318 using any of the mathematical function options mentioned in connection with step 314 or any other suitable manner of calculating log-odds contributions.

At step 319, for each of the N input variables, the AARG server 124 calculates a respective actual score based on the respective calculated log-odds contribution for the application data set. In at least one embodiment, the AARG server 124 carries out step 319 using Equation 4:

$$actual\_score ( {var}_{i} ) = \frac{- log \text{-} odds ( {var}_{i} ) * PDO}{ln ( 2 )} \qquad ( Eq . 4 )$$

where log-odds refers to the log-odds contribution for the respective variable as calculated in step 318, and where Equation 4 is otherwise identical to Equation 3. If an application comes in with a variable with a more negative log-odds contribution than the working minimum, then the log-odds contribution of the application variable is reassigned to be equal to the minimum working log-odds contribution. For example, if the working minimum log-odds contribution is −5 for a variable on the development dataset, and the log odds contribution for a variable on an application is −8, then the log-odds contribution for the variable on the application will be reassigned from −8 to −5.

At step 320, for each of the N input variables, the AARG server 124 calculates a score difference as the difference between the respective maximum score (calculated in step 316) and the respective actual (i.e., application-specific) score (calculated in step 319). This calculation is given by Equation 5:

score_difference(varᵢ)=maximum_score(varᵢ)−actual_score(varᵢ) (Eq. 5)

In the case of an application variable having a more negative log-odds contribution than the working minimum, the log-odds contribution of the application variable is reassigned to be equal to the working minimum log-odds contribution, which corresponds to an actual score equal to the maximum score, which in turn makes the score difference 0 under this example.

At step 321, the AARG server 124 outputs an adverse-action report associated with the particular application data set. In at least one embodiment, the adverse-action report includes a respective indication for each of a predefined number of the N input variables having the highest calculated score differences (as calculated in step 320). In at least one embodiment, the predefined number is between 1 and 10, inclusive. As examples, 4 or 5 such indications may be included in a given adverse-action report.

In at least one embodiment, outputting the adverse-action report involves transmitting the adverse-action report via a data connection to a remote device such as but not limited to one or more of the devices described in connection with FIG. 1. In at least one embodiment, outputting the adverse-action report involves one or both of storing and updating one or more data files in data storage based on the adverse-action report. Certainly, any combination of those outputting options could be implemented in a given context, as well as other means of outputting such as display on one or more screens, printing one or more documents, and/or the like.

In at least one embodiment, each indication in the adverse-action report includes an identification of the corresponding input variable, an adverse-action reason code that is associated with the corresponding input variable, and/or a definition of an adverse-action reason code that is associated with the corresponding input variable.

Thus, once the score differences have been calculated on a per-input-variable basis in step 320, the AARG server 124 in step 321 may sort the input variables in descending order of score difference, and then include in the generated adverse-action report a top group of one, some, or perhaps even all of the considered input variables. In some embodiments, adverse-action codes are issued responsive to a given variable's score difference exceeding a threshold, where such threshold could be common across multiple input variables or be input-variable-specific, depending on what may be suitable for a given implementation.

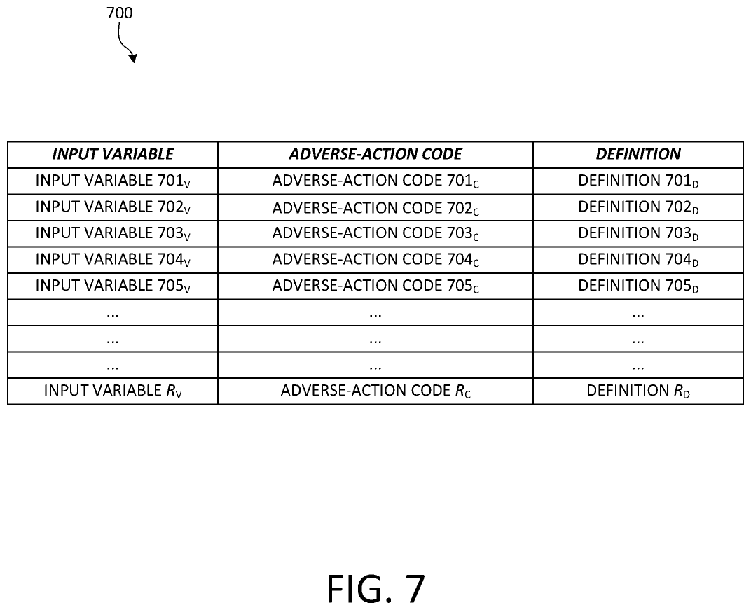

FIG. 7 is a diagram of an example structure of an example adverse-action reason-code data table, in accordance with at least one embodiment. In particular, FIG. 7 depicts the adverse-action reason-code data table 700, which, in at least one embodiment, the AARG server 124 stores in the data storage 206. In various different embodiments, whether carrying out the method 300, the method 700, or some variation of one or the other, the AARG server 124, upon identifying an input variable for inclusion in an adverse-action report to be outputted, the AARG server references the adverse-action reason-code data table 700, locates the row in which that identified input variable is listed, and accesses one or both of the corresponding adverse-action code and the corresponding definition of the corresponding adverse-action code for inclusion in the adverse-action report.

As shown in FIG. 7, the adverse-action reason-code data table 700 includes an arbitrary number R of input variables, corresponding to adverse-action codes, and adverse-action-definitions. In each row, the subscript “V” refers to “Variable,” the subscript “C” refers to “Code,” and the subscript “D” refers to “Definition.” Thus, for example, in the fourth row there is shown an input variable named “INPUT VARIABLE 704v,” an adverse-action code referred to as “ADVERSE-ACTION CODE 704c,” and a definition denoted as “DEFINITION 704D.”

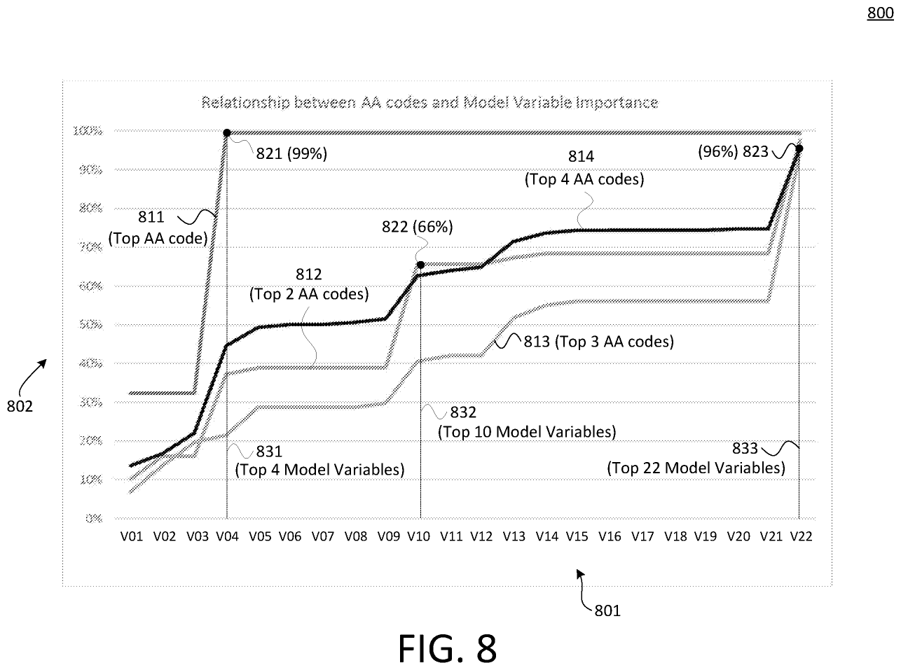

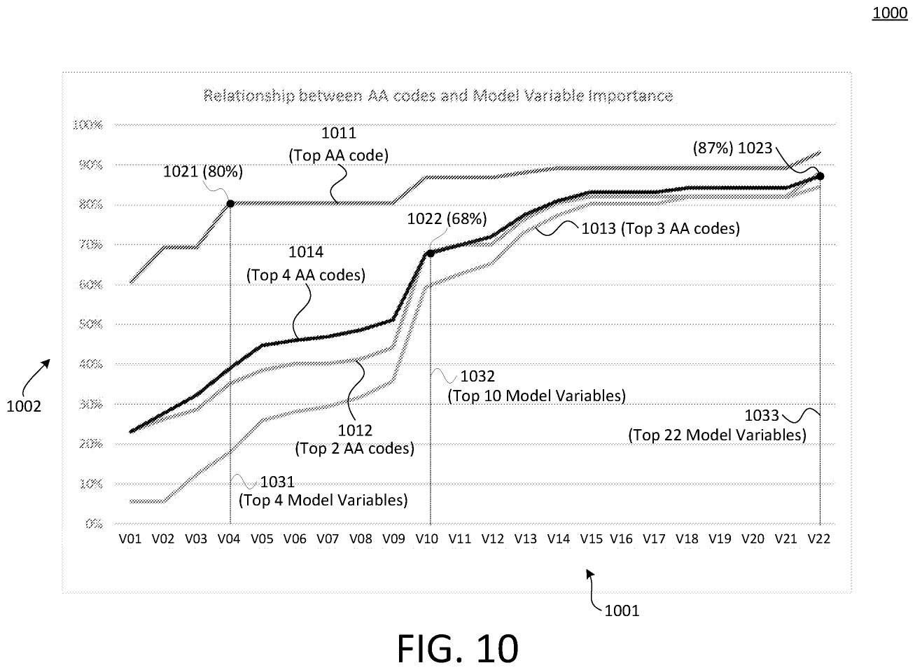

FIG. 8 is a graphical depiction of an example experimental correlation between top-ranked adverse-action codes and model-input-variable importance observed upon execution of the method 300, in accordance with at least one embodiment. The adverse-action codes that are referred to in this description of the graph 800 are those actually used by a different process to deny the associated credit applications. That process produces an ordered list of adverse-action codes ranked from highest to lowest with respect to their level of influence on the decision to deny the credit application. Both the graph 800 in FIG. 8 and the graph 1000 in FIG. 10 show high correlations between the input variables indicated by adverse-action reports produced according to the present systems and methods and the input variables corresponding to reason codes associated with reasons that the corresponding credit applications were denied.

The graph 800 has a horizontal axis 801 and a vertical axis 802. The horizontal axis 801 is delineated from left to right according to the 22 input variables used in this example. Each input variable on the horizontal axis 801 represents itself and each (if any) input variables to its left on the horizontal axis 801. Thus, as examples, “V01” just means variable V01, while “V10” means variables V01 through V10, and so on. Moreover, the variables listed on the horizontal axis 801 are ordered from left to right according to their importance ranking as determined by execution of the method 300. Thus, not only does “V10” mean variables V01-V10, it means in particular the 10 most important input variables (i.e., the 10 input variables having the highest difference between the maximum score for that input variable and the particular application's actual score for that input variable). V01 is the most important (i.e., had the highest score difference), V02 the second most important, and so on.

The vertical axis 802 is delineated in terms from 0% to 100% in 10% increments where the percentages reflect the fraction of experimental executions of the method 300 in which the generated adverse-action report included, in its corresponding set of indicated input variables from the horizontal axis 801, a certain number of the top one or more reason codes actually used to deny the corresponding credit application, where the number of reason codes is given by the description of the respective curves themselves, as described below.

The graph 800 includes a top-AA-code curve 811, a top-2-AA-codes curve 812, a top-3-AA-codes curve 813, and a top-4-AA-codes curve 814. Each point on each curve—in particular each point that is aligned above a variable-set indication on the horizontal axis 801—represents an experimental observation. The graph shows the corresponding variable set on the horizontal axis 801 and a percentage on the vertical axis 802. Three example points from the experimental data are listed below by way of illustration and by way of demonstration of the high experimental correlation between input variables identified by the method 300 and reason codes (associated with the same input variables) actually used to deny the corresponding credit applications.

As indicated by the point 821 (which is a point on the top-AA-code curve 811) and the vertical line 831, the experimental data showed that, in 99% of the experimental runs, the top 4 input variables (referred to in FIG. 8 as model variables) listed on the generated adverse-action report included the input variable corresponding to the top-ranked reason code used in denying the associated application. As indicated by the point 822 and the vertical line 832, the experimental data showed that, in 66% of the experimental runs, the top 10 input variables listed on the generated adverse-action report included the 2 input variables corresponding to the 2 top-ranked reason codes used in denying the associated application. And as indicated by the point 823 (which is a point on the top-4-AA-codes curve 814) and the vertical line 833, the experimental data showed that, in 96% of the experimental runs, the top 22 input variables indicated by the generated adverse-action report included the 4 input variables corresponding to the 4 top-ranked reason codes used in denying the associated application.

### B. Second Example Method

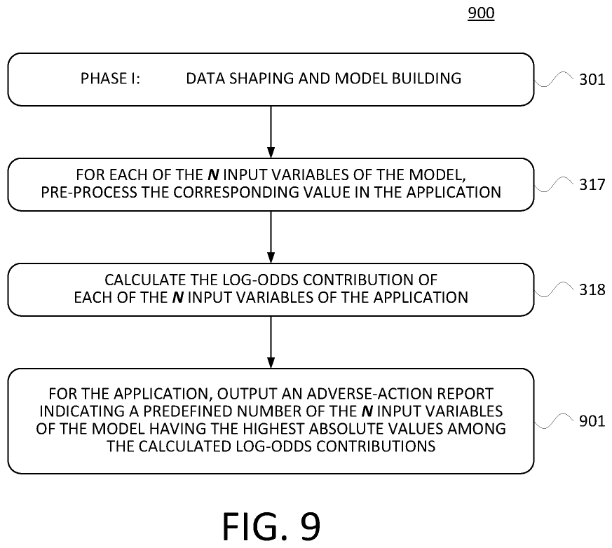

FIG. 9 is a flow chart of a second example method, in accordance with at least one embodiment. In the described embodiment, the method 900 of FIG. 9 is carried out by the AARG server 124, though in other embodiments it could be carried out by any computing and communication device that is suitably equipped, programmed, and configured. It is also noted that the method 900 includes three steps described above. Those steps are numbered as above and are not further described here.

At step 301, the AARG server 124 carries out the above-described steps 311, 312, and 313, including generating a machine-learning model having N monotonic input variables. At step 317, the AARG server receives an application data set that includes a respective value for each of the N input variables of the machine-learning model generated at step 301. At step 318, the AARG server calculates, based on the machine-learning model generated at step 301 and the respective values in the application data set received at step 317, a respective log-odds contribution for the application data set for each of the N input variables.

At step 901, the AARG server 124 outputs an adverse-action report associated with the application data set. The adverse-action report includes a respective indication for each of a predefined number of the N input variables having the highest absolute values of respective calculated log-odds contributions. In at least one embodiment, outputting the adverse-action report includes one or more of transmitting the adverse-action report via a data connection to a remote device, storing one or more data files in data storage based on the adverse-action report, and updating one or more data files in data storage based on the adverse-action report.

FIG. 10 is a graphical depiction of an example experimental correlation between top-ranked adverse-action codes and model-input-variable importance observed upon execution of the method 900, in accordance with at least one embodiment. In particular, FIG. 10 depicts a graph 1000 having a horizontal axis 1001 and a vertical axis 1002. The horizontal axis 1001 is delineated from left to right according to the 22 input variables used in this example. As is the case with the graph 800, each input variable on the horizontal axis 1001 represents itself and each (if any) input variables to its left on the horizontal axis 1001. Thus, for example, “V04” means variables V01 through V04, and so on, listed from left to right in order of importance (i.e., highest absolute value of log-odds contribution) as determined by the method 900. The vertical axis 1002 is delineated in terms from 0% to 100% in 10% increments where the percentages reflect the fraction of experimental executions of the method 900 in which the corresponding set of input variables (from the horizontal axis 1001) in the generated adverse-action report included the one or more input variables associated with a top-ranked set of one or more reason codes used to deny the application.

The graph 1000 includes a top-AA-code curve 1011, a top-2-AA-codes curve 1012, a top-3-AA-codes curve 1013, and a top-4-AA-codes curve 1014. These four curves are similar in definition to the curves 811-814 in FIG. 8. As indicated by the point 1021 (which is a point on the top-AA-code curve 1011) and the vertical line 1031, the experimental data showed that in 80% of the experimental runs, the top 4 input variables (referred to in FIG. 10 as model variables) listed on the generated adverse-action reports included the input variable corresponding to the top-ranked reason code used in denying the associated application.

As indicated by the point 1022 (which is a point on the top-2-AA-codes curve 1012) and the vertical line 1032, the experimental data showed that, in 68% of the experimental runs, the top 10 input variables listed on the generated adverse-action report included the 2 input variables corresponding to the 2 top-ranked reason codes used in denying the associated application. Finally, as indicated by the point 1023 (which is a point on the top-4-AA-codes curve 1014) and the vertical line 1033, the experimental data showed that, in 87% of the experimental runs, the top 22 input variables listed on the generated adverse-action report included the 4 input variables corresponding to the 4 top-ranked reason codes used in denying the associated application.

What is claimed is:

1. A method comprising:
for each of M training-data observations, calculating a respective log-odds contribution for each of N monotonic input variables of a machine-learning model;
for each of the N input variables, identifying a respective working minimum log-odds contribution;
for each of the N input variables, calculating a respective maximum score based on the identified working minimum log-odds contribution for the respective input variable;
receiving an application data set comprising a respective value for each of the N input variables of the machine-learning model;
calculating, based on the machine-learning model and the respective values in the application data set, a respective log-odds contribution for the application data set for each of the N input variables;
for each of the N input variables, calculating a respective actual score based on the respective calculated log-odds contribution for the application data set;
for each of the N input variables, calculating a score difference as the difference between the respective maximum score and the respective actual score; and
outputting an adverse-action report associated with the application data set, the adverse-action report comprising a respective indication for each of a predefined number of the N input variables having the highest calculated score differences.

2. The method of claim 1, further comprising generating the machine-learning model based on the M training-data observations

3. The method of claim 2, wherein generating the machine-learning model based on the M training-data observations comprises converting any of the N input variables that were previously non-monotonic input variables to being monotonic input variables.

4. The method of claim 1, wherein the identified working minimum log-odds contribution for a given input variable is a maximum calculated log-odds contribution of a predefined lowest percent of the calculated log-odds contributions for the given input variable.

5. The method of claim 1, wherein the application data set is associated with a credit application for which an adverse determination has been made.

6. The method of claim 1, wherein outputting the adverse-action report comprises transmitting the adverse-action report via a data connection to a remote device.

7. The method of claim 1, wherein outputting the adverse-action report comprises one or both of storing and updating one or more data files in data storage based on the adverse-action report.

8. The method of claim 1, wherein each indication in the adverse-action report comprises one or more of an identification of the corresponding input variable, an adverse-action reason code that is associated with the corresponding input variable, and a definition of an adverse-action reason code that is associated with the corresponding input variable.

9. The method of claim 1, wherein the predefined number is between 1 and 10, inclusive.

10. A system comprising:
a communication interface;
a processor; and
data storage that contains instructions executable by the processor for carrying out a set of functions, the set of functions comprising:
for each of M training-data observations, calculating a respective log-odds contribution for each of N monotonic input variables of a machine-learning model;
for each of the N input variables, identifying a respective working minimum log-odds contribution;
for each of the N input variables, calculating a respective maximum score based on the identified working minimum log-odds contribution for the respective input variable;
receiving an application data set comprising a respective value for each of the N input variables of the machine-learning model;
calculating, based on the machine-learning model and the respective values in the application data set, a respective log-odds contribution for the application data set for each of the N input variables;
for each of the N input variables, calculating a respective actual score based on the respective calculated log-odds contribution for the application data set;
for each of the N input variables, calculating a score difference as the difference between the respective maximum score and the respective actual score; and
outputting an adverse-action report associated with the application data set, the adverse-action report comprising a respective indication for each of a predefined number of the N input variables having the highest calculated score differences.

11. The system of claim 10, the set of functions further comprising generating the machine-learning model based on the M training-data observations

12. The system of claim 11, wherein generating the machine-learning model based on the M training-data observations comprises converting any of the N input variables that were previously non-monotonic input variables to being monotonic input variables.

13. The system of claim 10, wherein the identified working minimum log-odds contribution for a given input variable is a maximum calculated log-odds contribution of a predefined lowest percent of the calculated log-odds contributions for the given input variable.

14. The system of claim 10, wherein the application data set is associated with a credit application for which an adverse determination has been made.

15. The system of claim 10, wherein outputting the adverse-action report comprises transmitting the adverse-action report via a data connection to a remote device.

16. The system of claim 10, wherein outputting the adverse-action report comprises one or both of storing and updating one or more data files in data storage based on the adverse-action report.

17. The system of claim 10, wherein each indication in the adverse-action report comprises one or more of an identification of the corresponding input variable, an adverse-action reason code that is associated with the corresponding input variable, and a definition of an adverse-action reason code that is associated with the corresponding input variable.

18. The system of claim 10, wherein the predefined number is between 1 and 10, inclusive.

19. A method comprising:
generating a machine-learning model having N monotonic input variables;
receiving an application data set comprising a respective value for each of the N input variables of the machine-learning model;
calculating, based on the machine-learning model and the respective values in the application data set, a respective log-odds contribution for the application data set for each of the N input variables; and
outputting an adverse-action report associated with the application data set, the adverse-action report comprising a respective indication for each of a predefined number of the N input variables having the highest absolute values of respective calculated log-odds contributions.

20. The method of claim 19, wherein outputting the adverse-action report comprises one or more of transmitting the adverse-action report via a data connection to a remote device, storing one or more data files in data storage based on the adverse-action report, and updating one or more data files in data storage based on the adverse-action report.
